(19) United States
(12) Patent Application Publication
(10) Pub. No.: US 2010/0206224 A1
(43) Pub. Date: Aug. 19, 2010

(54) DEVICE FOR THE DEPOSITION OF LAYERS

(75) Inventors: Marc Thurner, Hauterive (CH); Yves Mussard, Peseux (CH)

Correspondence Address: YOUNG & THOMPSON, 209 Madison Street, Suite 500, Alexandria, VA, 22314, US

(73) Assignee: Berner Fachhochschule fur Technik und informatik HTI, Bienne (CH)

(21) Appl. No.: 12/679,521

(22) PCT Filed: Sep. 23, 2008
(86) PCT No.: PCT/EP08/62707

§ 371 Date: Mar. 23, 2010

(30) Foreign Application Priority Data
Sep. 24, 2007 (EP) 07117013.8

(51) Int. Cl. B05C 9/12; B05C 5/00

(52) U.S. Cl. 118/620; 118/323

(57) ABSTRACT

A device for the deposition of layers, includes a frame (10) provided with a housing (12), the frame further including: a table (22) for bearing an object to be manufactured and provided with a mobile plate (52) and first movement element (48), a material dispenser (20) for placing the material on the table (52) for manufacturing the object, provided with second movement element (34, 36, 38) for at least one vessel (40), at least one nozzle (42) and at least one extrusion member (44); a compacting element (23), and a control member (25) for controlling the material deposition on the table (22). At least the plate (52) and the end of the nozzle (42) are provided inside the housing (12), while at least the table movement element (48) and the dispenser movement element (34, 36, 38) and the control member (25) are provided outside the housing (12).

### FIELD OF THE INVENTION

The present invention relates to a device for the manufacture of an object through deposition of layers, in particular successive layers of a material forming a stratified structure in the object.

### DESCRIPTION OF THE PRIOR ART

Such devices are well-known, and are for example described in documents U.S. Pat. No. 5,136,515 and US 2003/209836. They include:
a frame bearing:
   a table designed to support an object to be manufactured and provided with a movable plate, first means for controlling a movement and first guide means,
   a material dispenser, designed to arrange this material on the table in order to form said object, provided with second means for controlling a movement and second guide means, at least one container in which the material is found, at least one nozzle connected to the container and allowing the passage of the material toward said table, and at least one extrusion member,
   compacting means for making the material thus deposited compact and solid, and
a control member designed to control the table and the dispenser in order to move the table and the dispenser in relation to each other and to control the deposition of material on the table.

Such devices in particular enable the manufacture of bone implants in biocompatible materials, by deposition of successive layers. The manufacture of these implants must be done with multiple precautions, so as to avoid them being a source of infection. The implants must therefore be manufactured in a sterile framework, with completely clean materials in the medical sense of the term. They must be packaged, then transported under conditions allowing complete traceability. Taking all of these precautions is very costly.

Document U.S. Pat. No. 4,976,582 also discloses a device for manufacturing an object through layer deposition and whereof the plate can furthermore be equipped with a flexible membrane closing a sterile enclosure. During the manufacture of the object, the nozzle of the dispenser must penetrate said enclosure beforehand, by piercing thereof. Such a device makes it possible to reduce the risks of infection of the manufactured implant, but through the principle of successive layer deposition, the initially sterile enclosure will have to be pierced with a large number of holes, making it particularly difficult to maintain sufficient sterility conditions. Moreover, when the enclosure is pierced with many holes, it becomes particularly difficult or even impossible to act on the environmental conditions of the enclosures. It will be impossible, for instance, to maintain a significant overpressure in the enclosure, during or after the manufacture of the object.

One aim of the present invention is to allow the manufacture of implants having sufficient sterility to be implanted in complete safety while reducing the manufacturing costs.

### BRIEF DESCRIPTION OF THE INVENTION

This aim is achieved thanks to the fact that, according to the invention, the frame is furthermore provided with an enclosure inside which at least the plate and the end of the nozzle are arranged, and outside this enclosure at least the means for controlling the movement of the table and of the dispenser and the control member are arranged. In this way, the implant can be manufactured directly in the operating room in which the implant must be put into place, or in a production environment meeting the standards necessary for the manufacture of medical implants such as GMP (Good Manufacturing Practice), thereby reducing the risks of infection and contamination of patients.

In order to ensure rapid curing of the deposited materials and obtaining of the required shapes, the compacting means are of the electromagnetic radiation type and work in a wavelength corresponding to the color blue.

It is possible to realize a device occupying a minimal volume, while still having very high working speeds thanks to the fact that the guide means of the table are of the parallel type, for example as described in patent U.S. Pat. No. 4,976,582.

In order to allow the realization of implants of heterogeneous composition, with an open pore matrix structure and wherein bioactive materials are found, the dispenser includes several containers and several nozzles, at least one nozzle per container.

Optimal conditions for manufacturing the object can be obtained with an extrusion member of the piezoelectric type. This makes it possible to dispense the material at a high speed and a very precise dosing. This technology allows the synchronization of the movement of the table and the dosing of the deposited material, which guarantees optimal homogeneity of the deposited pattern.

The present invention also concerns the use of the device inside an operating block as means for manufacturing implants in situ.

### BRIEF DESCRIPTION OF THE DRAWINGS

The invention will be better understood upon reading the following description, provided as an example and in reference to the drawing in which:

FIGS. 1 and 2 illustrate the device according to the invention from the side and the front, respectively;

FIG. 3 shows a perspective view of a portion of the table and of the dispenser with which the device is equipped;

FIG. 4 is a cross-sectional view of a plate bearing the dispensers;

FIG. 5 is a cross-sectional view along a plane perpendicular to the axis Z of the drive means of the table;

FIGS. 6 and 7 illustrate an overall view and a detailed view, respectively, of another embodiment of the device;

FIG. 8 shows an opening means of the device, in order to allow the extraction of an implant after manufacture;

FIGS. 9 to 12 illustrate the steps to construct an implant using the device according to the invention; and

FIG. 13 diagrammatically illustrates a portion of the operating room according to the invention.

### DETAILED DESCRIPTION OF THE INVENTION

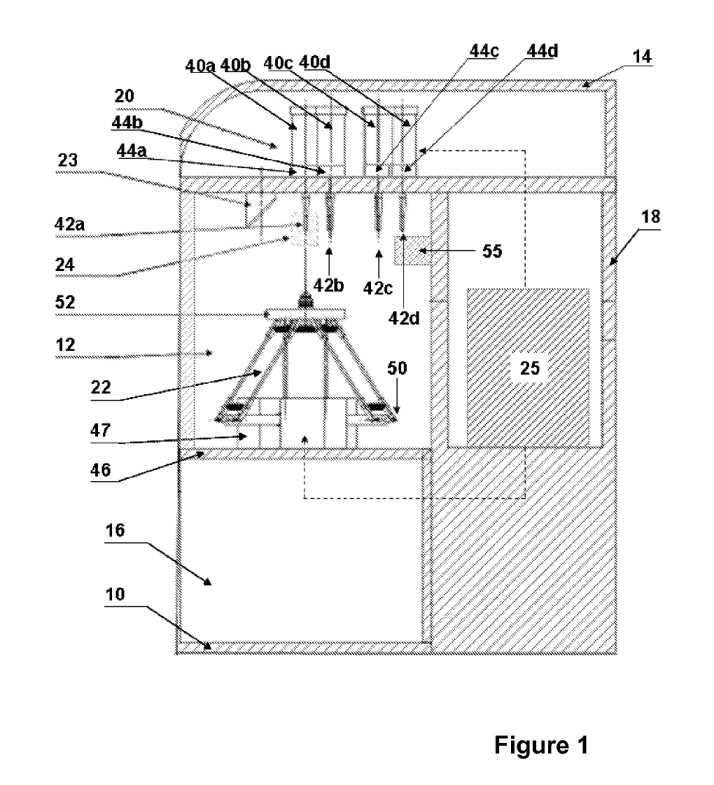

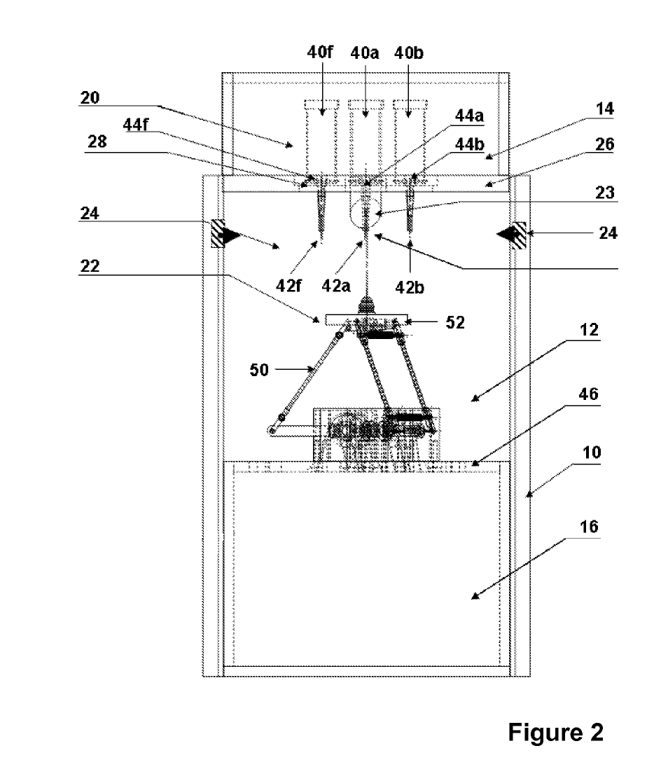

The device illustrated in FIGS. 1 and 2 comprises a frame 10 provided with partitions and doors which define four housings 12, 14, 16 and 18, inside which are arranged a dispenser 20, a movable table 22 and compacting means 23, which will be described more precisely below, as well as a position sensor 24 and a control member 25.

The walls forming the central housing 12 are fixed on the frame 10, in a manner well known by one skilled in the art, in order to form an enclosure sufficiently sealed to ensure its cleanliness, and thereby avoid physical elements (e.g. dust or textile fibers), biological elements (e.g. bacteria, viruses or any other type of micro-organism) or chemical elements (molecules in gaseous, solid or liquid form) from penetrating inside the housing 12, condition which is crucial to ensure a sterile environment as required for the manufacture of medical implants.

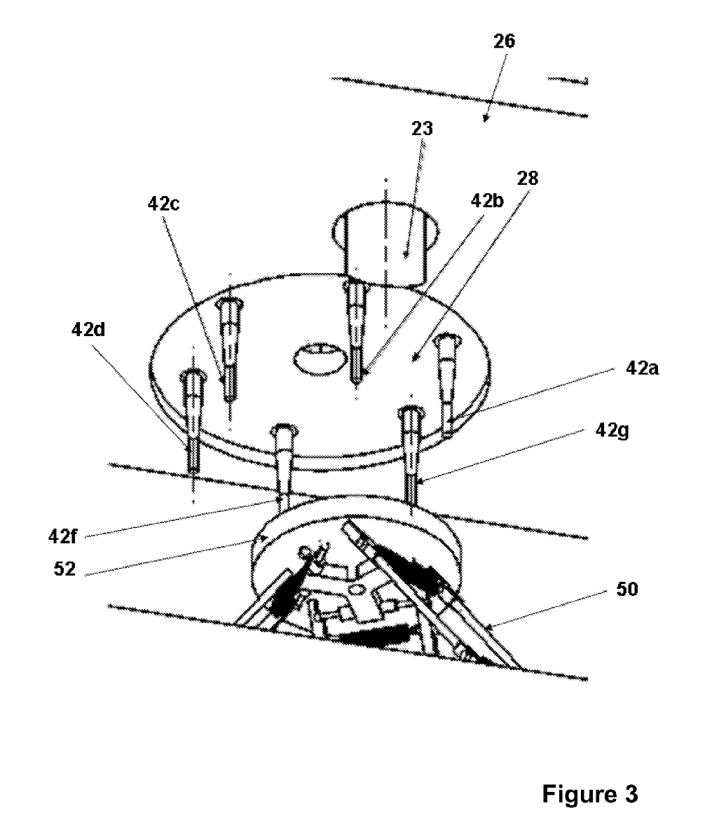

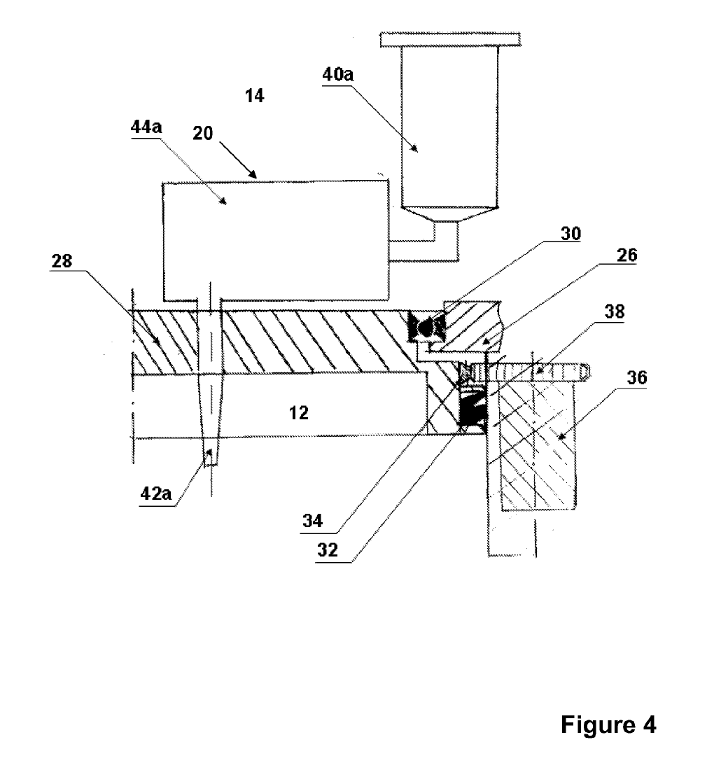

As can be seen more precisely in FIGS. 3 and 4, the upper wall of the housing 12, which also forms the bottom of the housing 14, includes a fixed partition 26 pierced with a circular hole wherein a rotating plate 28 is mounted. A ball bearing 30 and a sealing joint 32 are inserted between the partition 26 and the plate 28. They make it possible, respectively, to ensure precise pivoting and to ensure sealing between the housings 12 and 14.

The plate 28 also bears, on the housing 14 side, a toothed wheel 34 of small pitch designed to allow its driving. The partition 26 bears a motor assembly 36 equipped with an indexing system, which makes it possible to determine the angular position of the plate 28, and bearing a pinion 38 with gearing and meshing with the wheel 34. Such a structure makes it possible to position the plate 28 with a precision in the vicinity of five microns. The plate 28 and the ball bearing 30 form the guide means of the dispenser 20, whereas the toothed wheel 34, the motor 36 and the pinion 38 form the movement control means.

The plate 28 also bears the dispenser 20, which comprises six containers 40a to 40f each containing one of the materials to be dispensed, six nozzles 42a to 42f, each connected to one of the containers, and six extrusion members 44a to 44f, each ensuring the extrusion of the material contained in one of the containers 40a to 40f and to cause it to come out into the housing 12 through the nozzles, as will be explained later. It is noteworthy that some of the containers and the extrusion members are not visible in the figures. The containers 40 and the extrusion members 44 are in housing 14 while the free end of the nozzles 42 is in housing 12.

Advantageously, each of the six nozzles 42 could be mounted on the plate 28 via a support with micrometric screw, allowing adjustment of its position along vertical axis Z, the actuation of the micrometric screw being able to be manual or motorized. In order to ensure sealing between the plate 28 and the nozzles 42, it is possible to insert a bellows-type seal. Such a solution is easily accessible by one skilled in the art. This is why it is not illustrated, in order to avoid overloading the drawing.

The assemblies which make up each of the containers 40, nozzles 42 and extrusion members 44 are marketed by many companies. One of them is also described in U.S. Pat. No. 6,173,864.

The extrusion members 44a to 44f are of the piezoelectric type, thereby guaranteeing a very precise dosing of the material extracted from their respective containers and optical deposition conditions, as will be explained later.

The lower wall of the housing 12 is formed by a plate 46 on which the table 22 is mounted. The latter part has a parallel-type structure, as defined in U.S. Pat. No. 4,976,582. It comprises cases 47 sealably fixed on the plate 46, open toward the housing 16 and inside which are arranged motors 48 whereof the rotor can turn in both directions, reduction gears and indexing means. The motors 48 form the means for controlling the movement of the table 22. The motors 48 used can be with EC (Electronic Commutation), DC (Direct Current) or stepping technology, which one skilled in the art can easily implement. Likewise, the reduction gears are, according to known techniques, reduction gears without play, of the harmonic drive or planetary type, and the indexing means can be encoders of the Sin/Cos or TTL type.

Shafts 49 pass through the wall of the cases 47 and open into the housing 12. These shafts 49 are connected to their respective motors via the reduction gear. The shafts 49 are each connected to an articulated arm 50 of the structure of the table 22. The arms 50 form the guide means of the table 22. As is common with so-called parallel structures, the ends of the arms 50 are connected by articulation to a plate 52 (FIGS. 1 to 3). The latter part is designed to receive the object to be created, as will be explained later. It may be round in shape, with a diameter in the vicinity of 20 to 50 mm, or more depending on the piece to be manufactured. The plate 52 can also advantageously be assembled to the articulated arms 50 able to be clipped on, according to known techniques, in order to facilitate its placement and removal from the device.

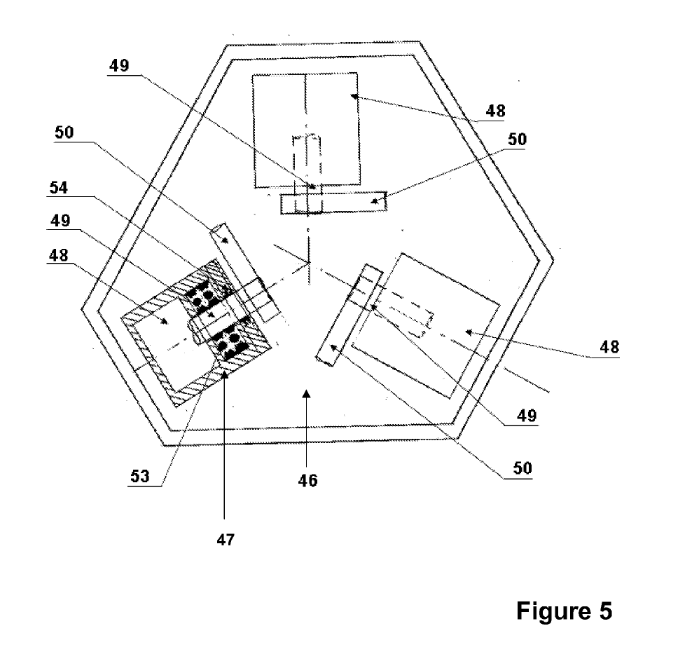

As can be seen more particularly in FIG. 5, the shafts 49 are mounted on ball bearings 53 arranged in the cases 47. A sealing joint 54 is inserted between the shaft 49 and the wall of the case 47, so as to ensure the cleanliness of the housing 12.

The compacting means 23 are made up of a blue light source, having a wavelength typically between 450 nm and 500 nm, mounted on one of the side walls of the housing 12. It can be formed, for example, by a laser as sold by the company Blue Sky Research 1537 Centre Pointe Drive Milpitas, Calif. 95035, emitting in the blue range.

The position sensor 24 is of the optical type. It is fixed on the side walls of the housing 12. Its aim is to precisely determine the position of the end of the nozzles 42 along the vertical axis Z in their working position, this position being the most difficult to control in the device as described above. It is possible to correct a positioning flaw in either nozzle 42 by moving the nozzle using a micrometric screw as explained above, or by slightly modifying the position of the plate 52.

The control member 25 is arranged in the housing 18. It is made up of a computer connected by suitable means, for example wires, to the motors and to the indexing means of the table 22, to the extrusion members 44, the compacting means 23 and the position sensor 24. It is provided with a monitor and a keyboard, which allow programming and control of the assembly. The control member 25 could also be arranged outside the frame, and connected to the other members of the device by radio relay, for example.

The housing 12 also comprises a tub 55 designed to make it possible to purge the assemblies formed by the containers 40, nozzles 42 and extrusion members 44 (FIG. 1).

The device also includes means making it possible to act on the environmental parameters of the housing 12. The environmental parameters which can be modified are:
temperature,
hygrometry level,
pressure (overpressure or under-pressure),
gaseous composition,
electromagnetic environment.

In order to ensure monitoring of the gaseous composition of the housing 12, orifices are formed in the frame 10 or in the tank 101. One skilled in the art will know how to place the orifices appropriately in order to produce a homogenous gaseous mixture inside the housing 12, considering in particular the density of the injected gas.

Acting on the environmental parameters allows the sterilization of the housing 12, using one of the techniques described in the following table:

| Type | Autoclave | ETO | Plasma |
|---|---|---|---|
| Temperature | 121 to 200° C. | 30 to 50° C. | — |
| Hygrometry | 0 to 80% | 40 to 90% | — |
| Pressure | 10⁻⁴ to 2 bars | — | 0.7 mbar |
| Gaseous | Steam | Ethylene oxide | Hydrogen |
| composition | | | peroxide |
| Other | — | — | Radio |
| | | | frequencies |
| | | | 300 W |

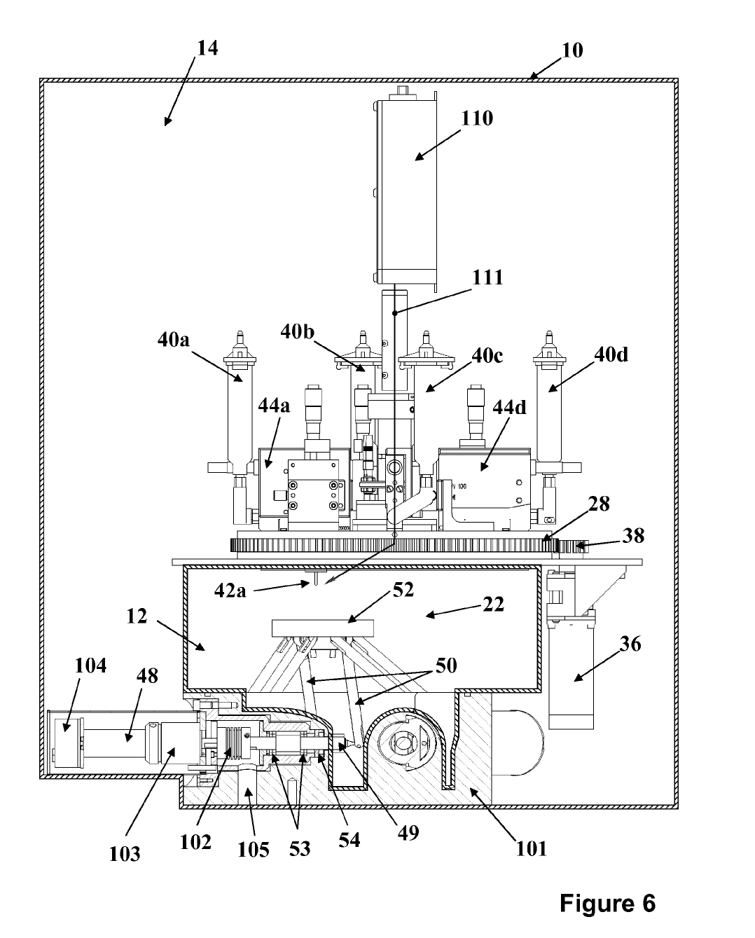

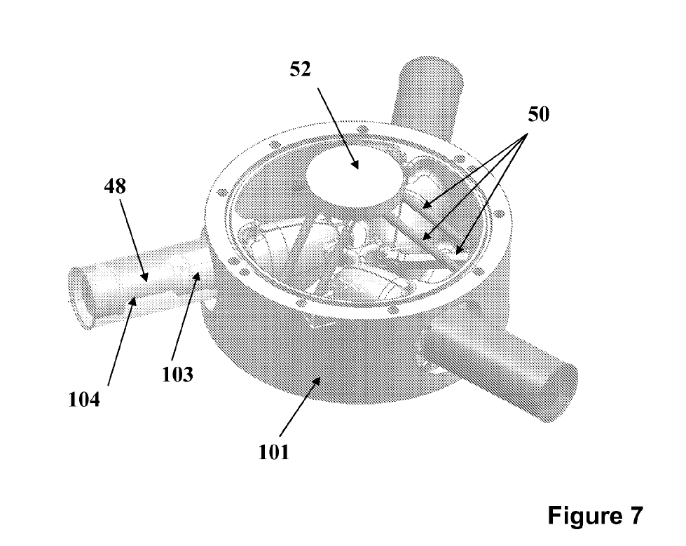

Another embodiment is presented, referring to FIGS. 6 and 7. The elements shared with the previously described alternative are designated using the same numbers and are not described in detail for this alternative.

The structure of the bottom of the housing 12 is, according to this alternative, formed in a single piece, a tank 101 designed to receive the movable table 22. Housings are machined in the tank 101, and designed to receive the motors 48 and the shafts 49, allowing the driving of the articulated arms 50. The tank 101, realized traditionally according to molding and machining methods, makes it possible to improve the sealing of the housing 12, by limiting the number of its openings. The shape of the tank 101 is also optimized such that the significant force generated by the pressure during the sterilization does not create mechanical deformation of the drive elements of a nature to influence the precision of the machine. FIG. 6 also shows the reduction gears 103 and the indexing means 104.

According to this alternative, the connection between the motor 48 and the shaft 49 is realized using a flexible coupling 102, for example available from the company RW Kupplungen, Germany. The use of such a flexible coupling 102 makes it possible to limit the heat exchanges between the housing 12 on one hand and the reduction gears 103, motors 48 and indexing means 104 on the other. Furthermore, cooling orifices 105 are formed in the tank 101 in order to make it possible, if the heat transmitted were to become too strong despite the presence of the flexible coupling 102, to cool the shafts 49 through injection of a cooling fluid, typically compressed air. This principle makes it possible to guarantee that the temperature of the drive elements situated outside the housing 12 does not exceed 60° C., despite a sterilization temperature which may reach 200° C.

In reference to FIG. 6, the means for compacting the material dispensed by the nozzles 42 is made up of a laser, of a model identical or similar to that described above, but the particularity of which is to be advantageously situated outside the housing 12. The laser beam produced, symbolized by arrow 111, is then guided, by optical means known by one skilled in the art, inside the housing 12 in which it penetrates via a glass surface (not shown), covering a hole formed in the rotating plate 28. The glass is assembled to the rotating plate 28 sealably, according to practices also known by those skilled in the art. Advantageously, the laser beam 111 enters into the housing 12 through the center of the plate 28, so that the positioning of the beam 111 is not modified during rotation of the plate 28, when, for example, another nozzle 42 must be used. This makes it possible to ensure that the laser beam 111 is always oriented so as to compact the material dispensed by the active nozzle 42 situated above the plate 52.

It is important to note that, according to this alternative, the housing 12 does not include any actuator or active sensor. As indicated above, this housing 12 can be subjected to very severe environmental stresses (primarily the temperature and pressure during autoclave sterilization). The present invention thus makes it possible to use material bearing “commercial” or “industrial” environmental stresses while subjecting the housing 12 to much more severe environmental conditions.

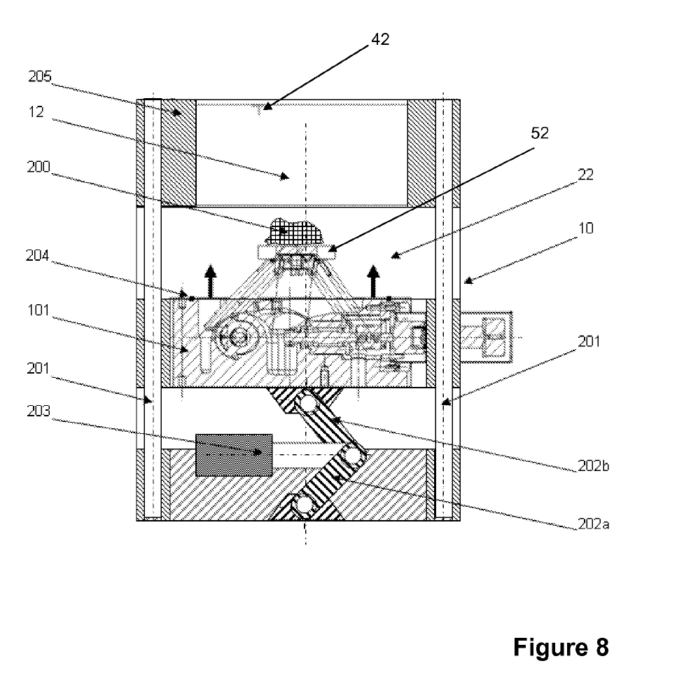

The present invention makes it possible to produce sterile implants while maintaining the necessary conditions inside the housing 12 before and during the manufacture of the implant. It will therefore generally, after manufacture, be manipulated by persons equipped at least with gloves or by automated arms, and it is therefore appropriate, once the implant is manufactured, to facilitate its extraction by arranging a sufficient opening of the housing 12. To this end, and relative to FIG. 8, the housing 12 is defined by the tank 101 and walls 205, the sealing being ensured, in closed position, by a joint 204. The opening of the housing 12 is done by translation of the tank 101 along the vertical axis Z. The tank 101 is mounted on guide rails 201 performing vertical guiding. An articulated arm 202, comprising two segments 202a and 202b, is fixed to the frame 10 and to the tank 101. One end of the segment 202a is connected by an articulation to the frame 10. One end of the segment 202b is connected by an articulation to the tank 101. The other end of the segment 202a is connected by an articulation to the other end of the segment 202b. The manipulation of the arm 202 is done using an actuator 203, the actuator 203 being, for example, a ball screw driven by an electric motor or any other type of linear motor. The actuator 203, controlled traditionally by the control member 25, allows the deployment or withdrawal of the arm 202, which results in moving the tank 101 vertically, upward and downward, respectively. Such an actuating principle is known by those skilled in the art by the name “toggle press”. In order to allow the extraction of an implant 200 under good conditions, the travel of the tank 101 is in the vicinity of 10 to 20 cm.

In closed position, the two segments 202a and 202b are advantageously vertically aligned. This configuration makes it possible, on one hand, to subject the joint 204 to significant compression and thereby ensure good sealing of the housing 12, and on the other hand to oppose great resistance at the opening, essential feature during the application of an overpressure in the housing 12, for example during an autoclave sterilization. Moreover, such a system makes it possible to present, in open position, a 360° opening around the implant to be extracted from the device.

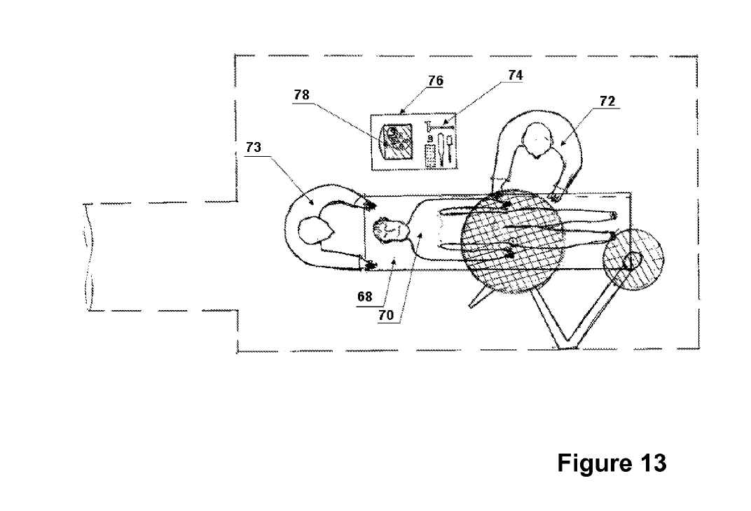

The device according to one of the alternatives just described makes it possible to realize 3D objects in a clean, or even sterile chamber, which can be placed directly in the location where the object must be used, in an operating room for example, or in a GMP production environment, in order to manufacture medical implants. Such an operating room will be described in more detail in reference to FIG. 13.

Once the implants are manufactured on site, in a sterile environment, the procedures and measures to be taken are simplified considerably. It is thus possible to substantially reduce the cost thereof, while improving their quality, in particular by reducing the risks of contamination of the patient.

The bone implants currently manufactured are advantageously realized in the form of a porous matrix, the pores of which are filled with bioactive materials, as described in U.S. Pat. No. 5,490,962 for example.

In order to realize a bone implant of this type, manufactured on the same site as its implantation, it is possible to proceed as follows.

There is cause to have the component materials of the implant, contained in the containers 40 which must be sterile.

The component material of the matrix may, for example, be a pasty mixture of calcium phosphate powder mixed with a binder such as PEG, PLA or PLLA, to which a photoinitiator is added such as that marketed by the company CIBA (CH) under the name Irgacure® 680. This photoinitiator has the effect of causing the polymerization of the binder when the latter is subjected to a blue radiation having a wavelength between 450 nm and 500 nm, typically 470 nm. Other photoinitiators may be considered, which may work from UV to IR without the procedure being fundamentally altered. The choice of a radiation in the blue color has the advantage of reducing the risk of partially destroying the bioactive materials.

Filling of the container is done in a sterile environment or a GMP environment, using a material which is itself is sterilized. The container is then arranged in a packaging guaranteeing the sterility of the container and its content. It will only be removed from this packaging upon placement of the container in the device.

The pores of the implant can be filled using bioactive or bioinductive materials, favoring, for example, the growth of bones or of veins and arteries. These are materials which assume the form of a hydrogel containing proteins and/or enzymes and/or cells promoting the regeneration of organs, whether involving bones or veins. This material, which can also be polymerized, also contains photoinitiator. For more information in this regard, it is advisable to see document US 2005/0065281.

The bioactive materials cannot be sterilized, due to the fact that their active ingredients would then be destroyed. They are therefore placed in a GMP environment, clean in the medical sense of the term, in containers sterilized beforehand. These containers are also placed in a protective packaging which is only removed at the last moment.

In order to manufacture an implant, its characteristics are introduced into the control member 25. This more particularly involves the proportion of the component materials and the structure of the implant.

Firstly, the housing 12 as well as the nozzles 42 are sterilized. The nozzles are sterilized using a gas source, chlorine dioxide or ethanol for example, introduced into the housing 14 and injected in the nozzles 42. The nozzles can also be sterilized by heating to +200° C. or by injection of pressurized water vapor, using techniques known by those skilled in the art.

The housing 12 is sterilized by one of the techniques mentioned above, by adjusting and controlling its temperature, hygrometry, pressure, gaseous composition and possibly its electromagnetic environment using means previously described.

The containers 40 are then placed by a sterilely equipped operator.

The control member 25 then ensures the filling of the nozzles 42, by successively placing each of them above the tub 55, the extrusion members 44 controlling the injection of material into the nozzles 42 until the latter parts are full.

The control member then brings the nozzle 42a above the plate 52, while the latter part is displaced along the axis Z such that the distance between the nozzle and the plate is completely adjusted, in the vicinity of 0.20 mm, defined by one skilled in the art and programmed into the control member 25. This distance is typically between: 0.10 to 0.30 mm, such that the deposition is done continuously, i.e. without the droplets created by the extrusion members 44 having the time to form. The distance between the nozzle 42 and the surface where the material must be deposited is verified using the position sensor 24. The latter part verifies the position of the nozzle 42, that of the plate 52 being considered sufficiently precise to serve as reference.

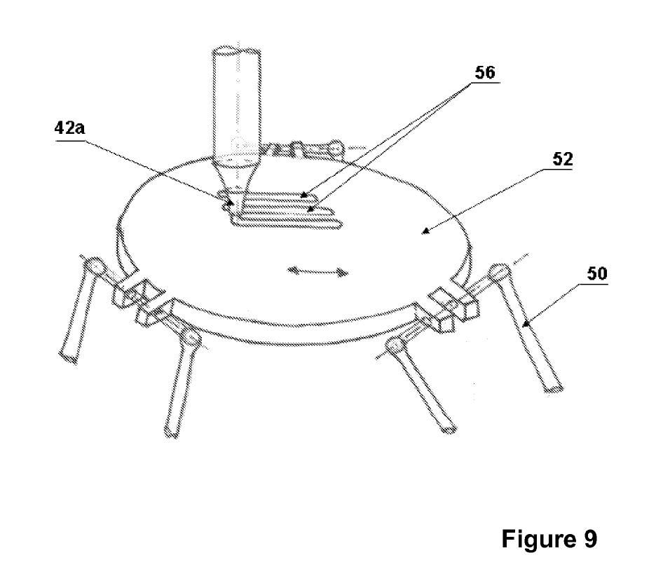

The movement of the plate 52 and the extrusion of the material from the container 40a toward the nozzle 42a by the actuation of the extrusion member 44a are done simultaneously, according to instructions given by the control member 25. As the pasty material is deposited by the nozzle 42a on the plate 52, it is made solid and compact by subjecting it to a blue radiation sent to the location where the material is deposited, by light emission of the compacting means 23. In this way, the material thus deposited is practically instantaneously solidified, preventing its spreading. It has a thickness typically between 0.10 mm and 0.30 mm, depending on the desired structure. As one can see in FIG. 9, the material contained in the container 40a is deposited in the form of lines 56 leaving grooves between them designed to receive other materials, as will be explained below (FIG. 9).

Once the first material, constituting the matrix, is deposited on the entire surface it must cover, the control member 25 causes the rotating plate 28 to turn in order to bring the nozzle 42b opposite the plate 52. The control member 25 verifies the position of the end of the nozzle 42b by querying the position sensor 24 and, if necessary, corrects the position of the plate 52 in reference to the end of the nozzle 42b.

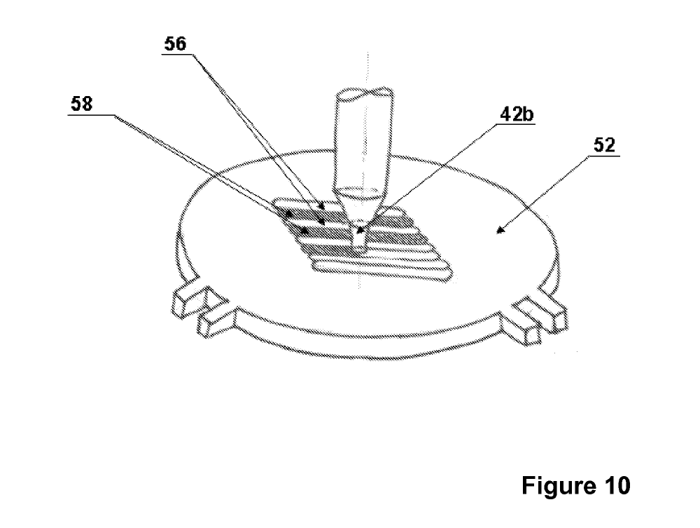

The control member 25 gives the orders creating the movement of the plate 52 and the extrusion of the material contained in the container 40b toward the nozzle 42b by the actuation of the extrusion member 44b. These operations are carried out simultaneously. Furthermore the compacting means 23 are also activated, polymerizing the deposited gel. This material is arranged in some of the spaces found between the lines 56 formed by the first material, in order to make up lines 58 (FIG. 10).

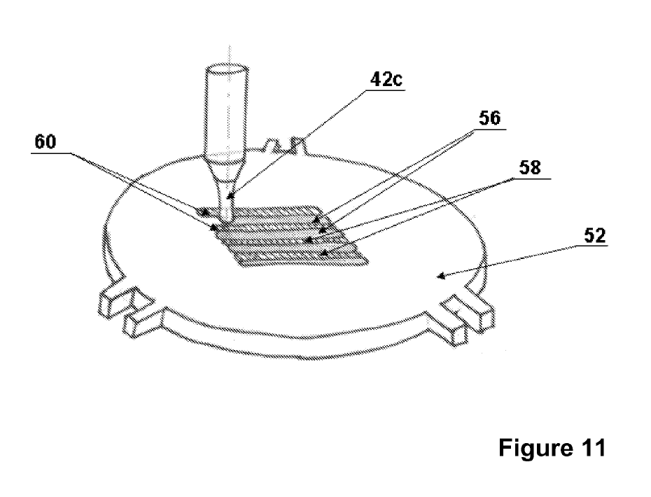

When the material is deposited in all of the preprogrammed spaces, the control member 25 causes the rotating plate 28 to turn in order to bring the nozzle 42c opposite the plate 52 (FIG. 11). The control member 25 verifies the position of the end of the nozzle 42c by querying the position sensor 24 and, if necessary, corrects the position of the plate 52 in reference to the end of the nozzle 42c.

The control member 25 gives the orders creating the movement of the plate 52 and the extrusion of the material from the container 40c toward the nozzle 42c by the actuation of the extrusion member 44c. These operations are carried out simultaneously. Furthermore the compacting means 23 are also activated, polymerizing the deposited gel. This material is arranged in some of the spaces found between the lines 56 formed by the first material, in order to make up lines 60, as shown in FIG. 11.

It will be noted that with a photoinitiator working at a wavelength of 470 nm, the biological components, in particular the cells, proteins and enzymes mentioned above, are not affected during the polymerization operation of the hydrogel.

A first layer 62, thus made up of the lines 56, 58 and 60, is then realized. The component materials form a compact but heterogeneous mass.

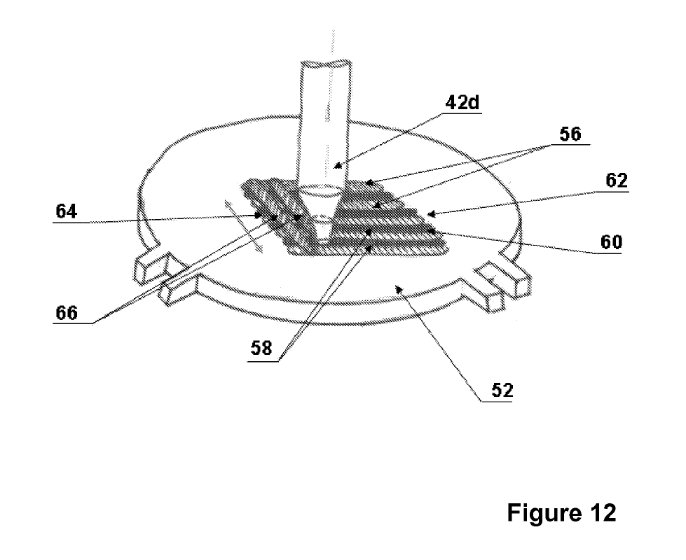

The control member 25 then prepares (FIG. 12) the device to deposit a second layer 64, superimposed on the layer 62 and comprising lines 66 whereof the orientation is different from that of the lines 56, 58 and 60, for example orthogonal. To this end, it places the nozzle 42d above the plate 52, according to the procedure previously described, and it moves the latter part along the axis Z, such that the space between the nozzle 42d and the layer 62 corresponds to the optimal deposition conditions.

The device then deposits lines 66 made up of the material contained in the container 40d polymerized during its placement. The container 40d can contain the same material as that contained in the container 40a or a different material.

The operations described relative to the deposition of the lines 58 and 60 are repeated to create separator lines, these latter lines being oriented parallel to the lines 66.

Thus, through successive layers, it is possible to create an implant made up of different biocompatible materials, some also being bioactive. The shape of these implants can be defined by programming the control member. It can simply involve a parallelepiped block, subsequently trimmed by the surgeon, or a piece having a more complex shape allowing implementation with minimal touch-ups.

FIG. 13 diagrammatically illustrates an operating room. One can see a table 68 on which a patient 70 is lying down. A surgeon 72 and his scrub nurse 73 are operating near the table 68. They have tools 74 arranged on a side table 76. An apparatus 78 as previously described is arranged under the side table 76.

In this configuration, when the implant is finished, manufactured directly in the sterile space of the operating room, the surgeon 72 can remove it from the plate 52 after having opened the door of the housing 12 and work it as he wishes before placing it in the body of the patient being operated on, of course in sterile environment. According to another alternative, relative to FIG. 8, the implant 200 can be removed by controlling the actuator 203, in order to cause the tank 101 to descend and thereby allow removal of the implant 200 from the plate 52.

Experience shows that the fact that the nozzles 42 remain immobile during the deposition while the plate 52 moves, makes it possible to ensure much more precise and regular deposition conditions than if it was the nozzles which moved. Furthermore, the compacting means 23 are also fixed, such that the illuminance of the deposition zone of the materials can be done with very great precision.

The conjunction of piezoelectric-type extrusion members with a movable plate, the nozzle remaining fixed, also makes it possible to realize a deposition of lines whereof both the thickness and the width can be controlled, despite significant variations in speed and direction, essential condition to ensure a rapid and precise manufacture of the implant.

Once the creation of the implant is done in the operating room, under optimal cleanliness and sterility conditions, the quality of the implant can be guaranteed, while also ensuring the simplest possible manufacture and management conditions.

It is obvious that the device according to the invention can present many alternatives without going outside the scope of the invention.

The structure of the implant can also be different from that described with, for example, a structure in which the deposited lines are all oriented in the same direction.

The use in the device of a serial-type table, for example, can also be considered. Such a solution does, however, require more space and make it difficult to control the cleanliness of the housing 12.

The number of nozzles and containers which the device must include can vary. It depends on the number of component materials of the implant and the volume of the latter part.

The means for monitoring the environmental conditions of the housing 12 can also advantageously be used in order to adjust and maintain optimal conditions before, during or after the manufacture of the implant.

A device as just described can also be used for purposes other than the manufacture of an implant. It could thus be used to manufacture objects by deposition of successive layers in a controlled atmosphere. In this case, it is essential that the enclosure formed by the housing 12 be connected to a gas source defining this controlled atmosphere. Depending on the gas used, it will also be necessary to provide means for removing it from the enclosure in a controlled manner.

It is also possible to form a film only including one layer, homogenous or not. Such a film could also find applications in the medical field.

The lines constituting the object to be manufactured can have orientations other than straight. It would, without others, be possible to arrange them in circles or spirals, or even according to a much more complex structure, in order to take into account the structure which the finished implant must have.

Moreover, the width of the lines can vary depending on the location where the deposition is done, by modifying the orders given by the control member to the dispenser 22.

Thus, thanks to the particular features of the device according to the invention, it is in particular possible to realize implants under optimal conditions, at a reduced cost.

1-11. (canceled)

12. A device for the deposition of layers, including:
a frame, provided with an enclosure including means for preventing physical, biological and chemical elements from penetrating inside said enclosure, said frame also bearing:
a table designed to support an object to be manufactured and provided with a movable plate, first movement control means and first guide means,
a material dispenser, designed to arrange said material on the table in order to form said object, provided with second movement control means and second guide means, at least one container, at least one nozzle allowing the passage of the material from the container toward said table, and at least one extrusion member,
compacting means for making the material thus deposited compact and solid, and
a control member designed to control the control means for the movement of the table and the dispenser in order to move the table and the dispenser in relation to each other and to control the deposition of material on the table,
wherein, inside the enclosure at least said plate and the end of said nozzle are arranged, and outside the enclosure at least the control means for movement of the table and the dispenser and the control member are arranged.

13. The device according to claim 12, wherein said compacting means are of the electromagnetic radiation type.

14. The device according to claim 13, wherein said compacting means are arranged in said enclosure.

15. The device according to claim 13, wherein said compacting means are arranged outside said enclosure, and wherein it also comprises third guide means of said electromagnetic radiation inside said enclosure.

16. The device according to claim 13, wherein said electromagnetic radiation corresponds to a light which is blue in color.

17. The device according to claim 12, wherein the first guide means of said table are of the parallel type.

18. The device according to claim 12, wherein said dispenser includes several containers and several nozzles, at least one nozzle per container.

19. The device according to claim 12, wherein said extrusion member is of the piezoelectric type.

20. The device according to claim 12, wherein it also includes means for adjusting and controlling environmental conditions inside the enclosure, the environmental conditions being chosen in particular among:
temperature,
hygrometry level,
pressure (overpressure or under-pressure),
gaseous composition,
electromagnetic environment.

21. The device according to claim 12, wherein the table is arranged in a tank mounted on vertical guide rails and arranged so as to be translated by an arm, said arm being capable of being actuated by a motor.

22. The device according to claim 13, wherein the first guide means of said table are of the parallel type.

23. The device according to claim 13, wherein said dispenser includes several containers and several nozzles, at least one nozzle per container.

24. The device according to claim 13, wherein said extrusion member is of the piezoelectric type.

25. The device according to claim 13, wherein it also includes means for adjusting and controlling environmental conditions inside the enclosure, the environmental conditions being chosen in particular among:
temperature,
hygrometry level,
pressure (overpressure or under-pressure),
gaseous composition,
electromagnetic environment.

26. The device according to claim 13, wherein the table is arranged in a tank mounted on vertical guide rails and arranged so as to be translated by an arm, said arm being capable of being actuated by a motor.

27. The use of the device according to claim 12 inside an operating block as means for manufacturing implants in situ.
